(19) United States
(12) Patent Application Publication
(10) Pub. No.: US 2023/0223972 A1
(43) Pub. Date: Jul. 13, 2023

(54) COMMUNICATION SYSTEM AND METHOD FOR SAR REDUCTION

(71) Applicant: MEDIATEK INC., Hsinchu City, TW (US)

(72) Inventors: Chung-Yu HUNG, Hsinchu City (TW); Jen-Chung CHIANG, Hsinchu City (TW)

(21) Appl. No.: 17/847,729

(22) Filed: Jun. 23, 2022

Related U.S. Application Data
(60) Provisional application No. 63/297,857, filed on Jan. 10, 2022.

(51) Int. Cl. H04B 1/04; H04B 17/13; H04W 52/22

(52) U.S. Cl. CPC H04B 1/0458; H04B 17/13; H04W 52/226; H04B 2001/0408

(57) ABSTRACT

A communication system for SAR (Specific Absorption Rate) reduction includes an RF (Radio Frequency), an antenna element, a coupler, and a controller. The RF module provides RF power. The antenna element is excited by the RF module. The coupler is coupled between the RF module and the antenna element. The controller receives antenna information from the coupler. The controller adjusts the level of RF power according to the antenna information.

### CROSS REFERENCE TO RELATED APPLICATIONS

This application claims the benefit of U.S. Provisional Application No. 63/297,857, filed on Jan. 10, 2022, the entirety of which is incorporated by reference herein.

### BACKGROUND OF THE INVENTION

### Field of the Invention

The disclosure generally relates to a communication system, and more specifically, to a communication system for SAR (Specific Absorption Rate) reduction.

### Description of the Related Art

With the advancements being made in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

An antenna is an indispensable component in a mobile device that supports wireless communication. However, antennas can easily be affected by an adjacent human body, which often interferes with the antenna and degrades the overall communication quality. Furthermore, the SAR may be too high to comply with regulations and laws. Accordingly, there is a need to propose a novel solution for solving the problems of the prior art.

### BRIEF SUMMARY OF THE INVENTION

In an exemplary embodiment, the disclosure is directed to a communication system for SAR (Specific Absorption Rate) reduction, and it includes an RF (Radio Frequency), an antenna element, a coupler, and a controller. The RF module provides RF power. The antenna element is excited by the RF module. The coupler is coupled between the RF module and the antenna element. The controller receives antenna information from the coupler. The controller adjusts the level of RF power according to the antenna information.

In some embodiments, the controller is implemented with a communication IC (Integrated Circuit).

In some embodiments, the coupler has a first port coupled to the RF module, a second port coupled to the antenna element, and a coupling port coupled to the controller.

In some embodiments, the coupler is switchable and controlled by controller to operate in a forward mode or a reverse mode.

In some embodiments, if the coupler operates in the forward mode, the controller will receive incident information of the antenna element from the coupler.

In some embodiments, if the coupler operates in the reverse mode, the controller will receive reflective information of the antenna element from the coupler.

In some embodiments, the controller calculates a reflection coefficient of the antenna element according to the antenna information.

In some embodiments, a power table is stored in the controller.

In some embodiments, the controller determines the level of RF power by looking up the reflection coefficient in the power table.

In some embodiments, the communication system further includes a transmission path coupled between the RF module and the coupler.

In some embodiments, the transmission path includes a DAC (Digital-to-Analog Converter), a first filter, a first mixer, a power amplifier, and/or a diplexer.

In some embodiments, the communication system further includes a detection path coupled between the coupler and the controller.

In some embodiments, the detection path includes an attenuator, an LNA (Low Noise Amplifier), a second mixer, a second filter, and/or an ADC (Analog-to-Digital Converter).

In some embodiments, the communication system does not use any proximity sensor.

In another exemplary embodiment, the disclosure is directed to a communication method for SAR, and it includes the following steps: exciting an antenna element via an RF (Radio Frequency) module, wherein a coupler is coupled between the RF module and the antenna element; receiving antenna information from the coupler; and adjusting the level of RF power of the RF module according to the antenna information.

In some embodiments, the communication method further includes: controlling the coupler to operate in a forward mode or a reverse mode.

In some embodiments, the communication method further includes: if the coupler operates in the forward mode, receiving incident information of the antenna element from the coupler.

In some embodiments, the communication method further includes: if the coupler operates in the reverse mode, receiving reflective information of the antenna element from the coupler.

In some embodiments, the communication method further includes: calculating a reflection coefficient of the antenna element according to the antenna information.

In some embodiments, the communication method further includes: determining the level of RF power by looking up the reflection coefficient in a power table.

### BRIEF DESCRIPTION OF DRAWINGS

The invention can be more fully understood by reading the subsequent detailed description and examples with references made to the accompanying drawings, wherein:

FIG. 1 is a diagram of a communication system according to an embodiment of the invention;

FIG. 2 is a diagram of a communication system according to an embodiment of the invention;

FIG. 3A is a diagram of a communication system in free space according to an embodiment of the invention;

FIG. 3B is a diagram of a communication system held by a left hand of a user according to an embodiment of the invention;

FIG. 3C is a diagram of a communication system held by a right hand of a user according to an embodiment of the invention;

FIG. 4 is a diagram of Smith chart of a communication system according to an embodiment of the invention; and

FIG. 5 is a flowchart of a communication method according to an embodiment of the invention.

### DETAILED DESCRIPTION OF THE INVENTION

In order to illustrate the purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

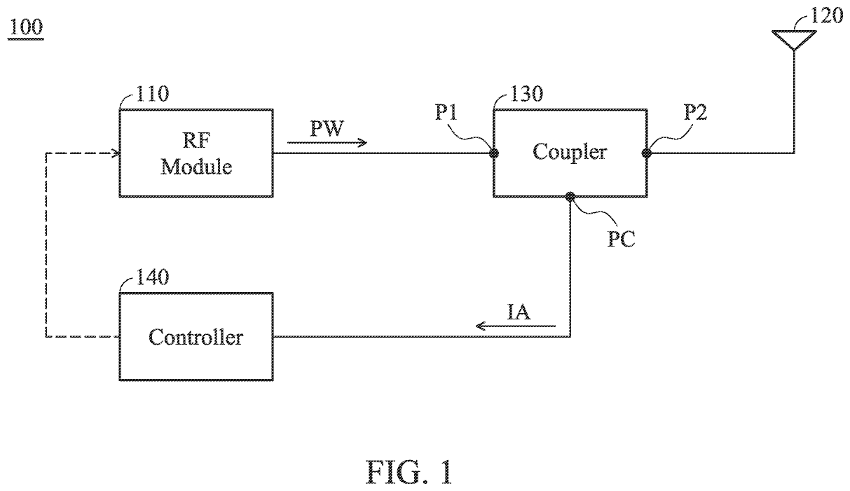

FIG. 1 is a diagram of a communication system 100 according to an embodiment of the invention. The communication system 100 may be applied to a mobile device, such as a smart phone, a tablet computer, or a notebook computer, but it is not limited thereto. As shown in FIG. 1, the communication system 100 includes an RF (Radio Frequency) module 110, an antenna element 120, a coupler 130, and a controller 140. It should be understood that the communication system 100 may include other components, such as a processor, a power supply module, a touch control panel, and/or a housing, although they are not displayed in FIG. 1.

The RF module 110 provides RF power PW. The antenna element 120 is excited by the RF module 110. The type and style of the antenna element 120 are not limited in the invention. For example, the antenna element 120 may be a monopole antenna, a dipole antenna, a loop antenna, a hybrid antenna, or a PIFA (Planar Inverted F Antenna). The coupler 130 is coupled between the RF module 110 and the antenna element 120. Specifically, the coupler 130 may have a first port P1 coupled to the RF module 110, a second port P2 coupled to the antenna element 120, and a coupling port PC coupled to the controller 140. In some embodiment, the controller 140 is implemented with a communication IC (Integrated Circuit). The controller 140 can receive antenna information IA from the coupler 130. The antenna information IA may be relative to any operational characteristics of the antenna element 120. The controller 140 can adjust the level of RF power PW according to the antenna information IA, thereby reducing the SAR (Specific Absorption Rate) of the communication system 100. With the proposed design of the invention, since the communication system 100 does not use any proximity sensors for SAR reduction, it can reduce the manufacturing cost, minimize the design area, and prevent sensors from negatively affecting the communication quality.

The following embodiments will introduce different configurations and detail structural features of the communication system 100. It should be understood that these figures and descriptions are merely exemplary, rather than limitations of the invention.

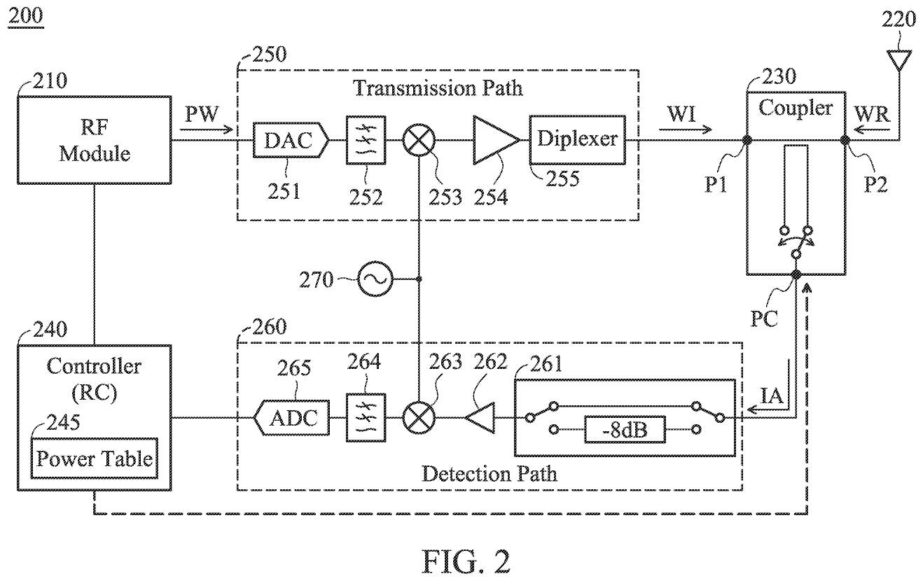

FIG. 2 is a diagram of a communication system 200 according to an embodiment of the invention. FIG. 2 is similar to FIG. 1. In the embodiment of FIG. 2, the communication system 200 includes an RF module 210, an antenna element 220, a coupler 230, a controller 240, a transmission path 250, a detection path 260, and a local oscillator 270.

The RF module 210 provides RF power PW. The antenna element 220 is excited by the RF module 210. The coupler 230 has a first port P1, a second port P2, and a coupling port PC. Specifically, the first port P1 of the coupler 230 is coupled through the transmission path 250 to the RF module 210. The second port P2 of the coupler 230 is coupled to the antenna element 220. The coupling port PC of the coupler 230 is coupled through the detection path 260 to the controller 240. The controller 240 can receive antenna information IA from the coupler 230. For example, the antenna information IA may be a voltage, a current, or a signal of any other type. The controller 240 can adjust the level of RF power PW according to the antenna information IA, thereby reducing the SAR of the communication system 200. Also, the communication system 200 does not use any proximity sensors.

In some embodiments, the coupler 230 is switchable and controlled by controller 240 to operate in a forward mode or a reverse mode. In the forward mode of the coupler 230, most of the energy is transmitted from the first port P1 to the second port P2, but a portion of the energy is transmitted from the first port P1 to the coupling port PC. If the coupler 230 operates in the forward mode, the controller 240 will receive incident information of the antenna element 220 from the coupler 230. The incident information may be a voltage, a current, or a signal of any other type. For example, the incident information may correspond to an incident signal WI, which is transmitted to the antenna element 220.

Conversely, in the reverse mode of the coupler 230, most of the energy is transmitted from the second port P2 to the first port P1, but a portion of the energy is transmitted from the second port P2 to the coupling port PC. If the coupler 230 operates in the reverse mode, the controller 240 will receive reflective information of the antenna element 220 from the coupler 230. The reflective information may be a voltage, a current, or a signal of any other type. For example, the reflective information may correspond to a reflective signal WR, which is received from the antenna element 220 in response to the incident signal WI.

In some embodiments, the controller 240 calculates a reflection coefficient RC of the antenna element 220 according to the antenna information IA. For example, the reflection coefficient RC may be determined according to the incident information and the reflective information as mentioned above, but it is not limited thereto. Furthermore, a power table 245 may be previously stored in the controller 240, and the controller 240 can determine the level of RF power PW by looking up the reflection coefficient RC in the power table 245. In some embodiments, the power table 245 records the detailed relationship between power level and reflection coefficient for a variety of different power levels and reflection coefficients.

The transmission path 250 is coupled between the RF module 210 and the first port P1 of the coupler 230. In some embodiments, the transmission path 250 includes a DAC (Digital-to-Analog Converter) 251, a first filter 252, a first mixer 253, a power amplifier 254, and/or a diplexer 255. The first mixer 253 is coupled to the local oscillator 270. The arrangements of the above components of the transmission path 250 are adjustable according to different requirements.

The detection path 260 is coupled between the coupling port PC of the coupler 230 and the controller 240. In some embodiments, the detection path 260 includes an attenuator 261, an LNA (Low Noise Amplifier) 262, a second mixer 263, a second filter 264, and/or an ADC (Analog-to-Digital Converter) 265. The second mixer 263 is coupled to the local oscillator 270. The arrangements of the above components of the detection path 260 are adjustable according to different requirements.

In alternative embodiments, the communication system 200 further includes a tuner (not shown) coupled between the antenna element 220 and the second port P2 of the coupler 230, and it is controlled by the controller 270 to optimize the system impedance matching. Other features of the communication system 200 of FIG. 2 are similar to those of the communication system 100 of FIG. 1. Therefore, the two embodiments can achieve similar levels of performance.

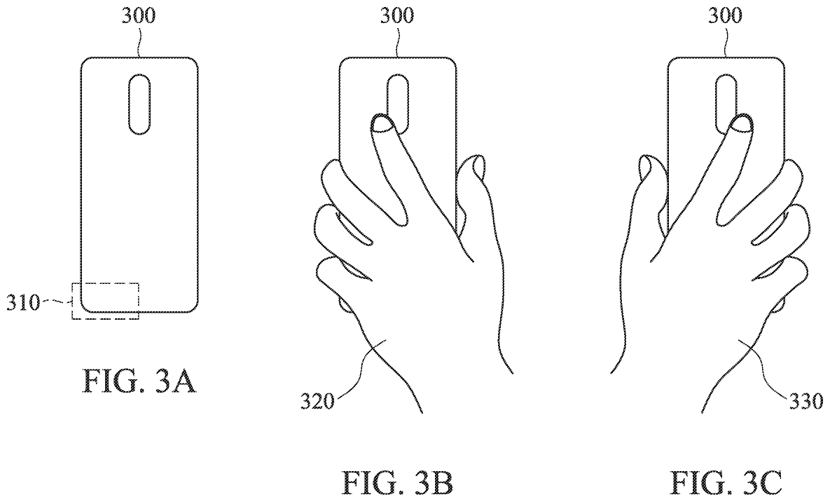

FIG. 3A is a diagram of a communication system 300 in free space according to an embodiment of the invention. The communication system 300 may be applied in a mobile phone. The aforementioned antenna element may be disposed at a specific position 310 of the mobile phone. FIG. 3B is a diagram of the communication system 300 held by a left hand of a user according to an embodiment of the invention. FIG. 3C is a diagram of the communication system 300 held by a right hand of the user according to an embodiment of the invention.

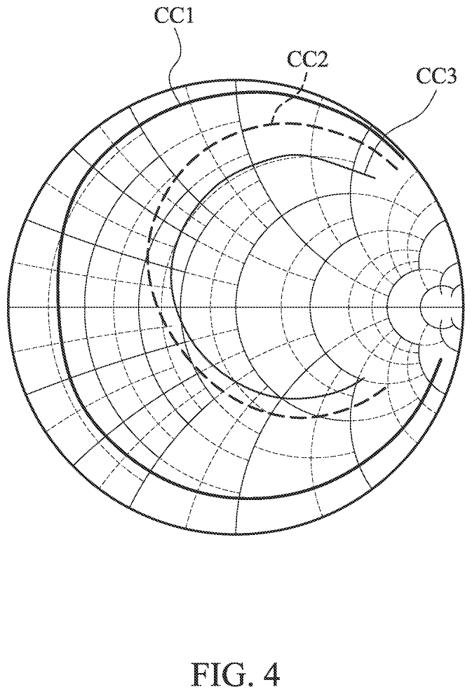

FIG. 4 is a diagram of Smith chart of the communication system 300 according to an embodiment of the invention. As shown in FIG. 4, a first curve CC1 represents the impedance characteristics of the communication system 300 when it is positioned in free space, a second curve CC2 represents the impedance characteristics of the communication system 300 when it is held by the left hand of the user, and a third curve CC3 represents the impedance characteristics of the communication system 300 when it is held by the right hand of the user. In some embodiments, the above characteristics can be previously recorded in the power table 245 of the controller 240, and they correspond to different power levels. By analyzing the antenna information IA (e.g., the reflection coefficient RC) according to the power table 245, the controller 240 can determine whether/how the communication system 300 is held by the user, and then select an appropriate level of RF power PW of the RF module 210 for SAR reduction.

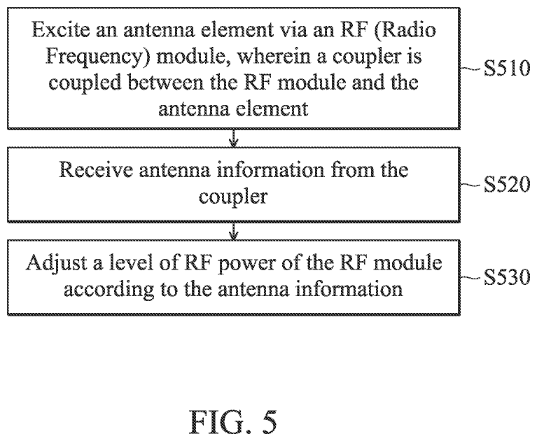

FIG. 5 is a flowchart of a communication method according to an embodiment of the invention. The aforementioned communication method includes the following steps. In the step S510, an antenna element is excited via an RF module. A coupler is coupled between the RF module and the antenna element. In the step S520, antenna information is received from the coupler. In the step S530, the level of RF power of the RF module is adjusted according to the antenna information. It should be noted that the above steps are not required to be performed in order, and all of the features of the embodiments of FIGS. 1 to 4 may be applied to the communication method of FIG. 5.

The invention proposes a novel communication system and a novel communication method thereof. Compared to the conventional design, the invention has at least the advantages of reducing the SAR, minimizing the design area, decreasing the manufacturing cost, and eliminating the interferences of proximity sensors, and therefore it is suitable for application in a variety of mobile communication devices.

Note that the above element parameters are not limitations of the invention. An designer can fine-tune these settings or values according to different requirements. It should be understood that the communication system and the communication method of the invention are not limited to the configurations of FIGS. 1-5. The invention may merely include any one or more features of any one or more embodiments of FIGS. 1-5. In other words, not all of the features displayed in the figures should be implemented in the communication system and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication system for SAR (Specific Absorption Rate) reduction, comprising:
an RF (Radio Frequency) module, providing RF power;
an antenna element, excited by the RF module;
a coupler, coupled between the RF module and the antenna element; and
a controller, receiving antenna information from the coupler;
wherein the controller adjusts a level of the RF power according to the antenna information.

2. The communication system as claimed in claim 1, wherein the controller is implemented with a communication IC (Integrated Circuit).

3. The communication system as claimed in claim 1, wherein the coupler has a first port coupled to the RF module, a second port coupled to the antenna element, and a coupling port coupled to the controller.

4. The communication system as claimed in claim 1, wherein the coupler is switchable and controlled by controller to operate in a forward mode or a reverse mode.

5. The communication system as claimed in claim 4, wherein if the coupler operates in the forward mode, the controller receives incident information of the antenna element from the coupler.

6. The communication system as claimed in claim 4, wherein if the coupler operates in the reverse mode, the controller receives reflective information of the antenna element from the coupler.

7. The communication system as claimed in claim 1, wherein the controller calculates a reflection coefficient of the antenna element according to the antenna information.

8. The communication system as claimed in claim 7, wherein a power table is stored in the controller.

9. The communication system as claimed in claim 8, wherein the controller determines the level of the RF power by looking up the reflection coefficient in the power table.

10. The communication system as claimed in claim 1, further comprising:
a transmission path, coupled between the RF module and the coupler.

11. The communication system as claimed in claim 10, wherein the transmission path comprises a DAC (Digital-to-Analog Converter), a first filter, a first mixer, a power amplifier, and/or a diplexer.

12. The communication system as claimed in claim 1, further comprising:
a detection path, coupled between the coupler and the controller.

13. The communication system as claimed in claim 12, wherein the detection path comprises an attenuator, an LNA (Low Noise Amplifier), a second mixer, a second filter, and/or an ADC (Analog-to-Digital Converter).

14. The communication system as claimed in claim 1, wherein the communication system does not use any proximity sensor.

15. A communication method for SAR (Specific Absorption Rate) reduction, comprising the steps of:
exciting an antenna element via an RF (Radio Frequency) module, wherein a coupler is coupled between the RF module and the antenna element;
receiving antenna information from the coupler; and
adjusting a level of RF power of the RF module according to the antenna information.

16. The communication method as claimed in claim 15, further comprising:
controlling the coupler to operate in a forward mode or a reverse mode.

17. The communication method as claimed in claim 16, further comprising:
if the coupler operates in the forward mode, receiving incident information of the antenna element from the coupler.

18. The communication method as claimed in claim 16, further comprising:
if the coupler operates in the reverse mode, receiving reflective information of the antenna element from the coupler.

19. The communication method as claimed in claim 15, further comprising:
calculating a reflection coefficient of the antenna element according to the antenna information.

20. The communication method as claimed in claim 19, further comprising:
determining the level of the RF power by looking up the reflection coefficient in a power table.
